(19) United States
(12) Patent Application Publication
(10) Pub. No.: US 2025/0165799 A1
(43) Pub. Date: May 22, 2025

(54) TRAINING DATA GENERATION APPARATUS, TRAINING DATA GENERATION METHOD AND PROGRAM

(71) Applicant: NIPPON TELEGRAPH AND TELEPHONE CORPORATION, Tokyo (JP)

(72) Inventors: Yoichi MATSUO, Tokyo (JP); Keishiro WATANABE, Tokyo (JP)

(21) Appl. No.: 18/840,569

(22) PCT Filed: Mar. 29, 2022
(86) PCT No.: PCT/JP2022/015591

§ 371 Date: Aug. 22, 2024

(51) Int. Cl. G06N 3/094; G06N 3/0475

(52) U.S. Cl. CPC G06N 3/094; G06N 3/0475

(57) ABSTRACT

A learning data generation apparatus is a learning data generation apparatus generating learning data used to learn a model for estimating an abnormal portion of an ICT system. The learning data generation apparatus includes: a learning unit configured to learn parameters of a generator and a discriminator forming a conditional hostile generation network by using observation data during abnormality of the ICT system; and a generation unit configured to generate the learning data using the generator in which the learned parameters are set.

### TECHNICAL FIELD

The present disclosure relates to a learning data generation apparatus, a learning data generation method, and a program.

### BACKGROUND ART

One of the important tasks of a service provider operating an information and communication technology (ICT) system is to ascertain a state of an abnormality occurring in the ICT system and to quickly cope with the abnormality. Therefore, a scheme for detecting an abnormality occurring in an ICT system early and a scheme for estimating an abnormal portion have been studied (for example, NPL 1 and NPL 2). As schemes for estimating an abnormal portion, for example, a scheme described in NPL 3, a scheme described in NPL 4, and the like have been proposed. NPL 3 proposes a scheme for modeling a relationship between an abnormal portion and a change in data in an ICT system caused in the abnormal portion as a causal model by using a Bayesian network, and estimating the abnormal portion from data observed during abnormality. NPL 4 proposes an abnormality factor identifying scheme by generating fault data by chaos engineering.

Here, when an abnormal portion is estimated by the causal model, there are two methods of constructing the causal model. The first method is a method of defining and modeling an abnormal portion and a rule of a change in data in an ICT system caused by the abnormal portion based on knowledge or the like of an expert operator (for example, NPL 3). The second method is a method of constructing a causal model from an abnormal portion during past abnormality and data at that time. In the studies of the related art, a causal model is constructed by one of the two methods and an abnormal portion is estimated.

In general, only a small amount of data during a fault can be obtained on an ICT system. However, in chaos engineering, a fault is intentionally inserted into the ICT system, and an abnormal portion and data at that time are collected. Accordingly, the collected data can be used for modeling a Bayesian network or can be used for learning data such as a support-vector machine (SVM), and an abnormal portion and a factor can be estimated.

### CITATION LIST

### Non Patent Literature

NPL 1 K. Tajiri, T. Iwata, Y. Matsuo and K. Watanabe, “Fault Detection of ICT systems with Deep Learning Model for Missing Data,” 2021 IFIP/IEEE International Symposium on Integrated Network Management (IM), 2021, pp. 445 to 451.
NPL 2 Y. Matsuo, Y. Nakano, A. Watanabe, K. Watanabe, K. Ishibashi, and K. Kawahara, “Root-cause diagnosis for rare failures using Bayesian network with dynamic modification,” Proc. IEEE, ICC, 2018.
NPL 3 Srikanth Kandula, Dina Katabi, and Jean-philippe Vasseur. Shrink: A tool for failure diagnosis in IP networks. Proceedings of the 2005 ACM SIGCOMM workshop on Mining network data, pages 173-178, 2005.
NPL 4 Koki Ikeuchi, Yoshibumi Kuzu, Keishiro Watanabe, “A study on factor identifying scheme based on generation of fault data”, General meeting of the Institute of Science and Technology, B-7-32, March 2020

### SUMMARY OF INVENTION

### Technical Problem

The two construction methods of the causal models in the studies of the related art have problems. First, in the first method, there is a problem that an abnormal portion cannot be correctly estimated when an abnormality other than a defined rule occurs. In particular, it is difficult to construct a causal model by covering an abnormality which can occur in the ICT system in advance and, as a result, it may not be possible to estimate the abnormal portion correctly in some cases.

Next, the second method has a problem that it is difficult to sufficiently collect data during an abnormality necessary to construct the causal model. This is because an ICT system generally rarely generates an abnormality, and even if an abnormality occurs, a recurrence prevention measure is taken so that the same abnormality does not occur again. In the second method, a causal model is constructed based only on past abnormalities, so that the causal model cannot cope with unknown abnormalities, and an abnormal portion cannot be estimated.

Chaotic engineering is likely to partially solve the problem that it is difficult to sufficiently collect data during abnormality necessary to construct a causal model, but cannot be said to suffice. This is because a wide variety of abnormalities occur in an ICT system, but chaos engineering is a method of intentionally inserting a fault, and thus only data related to abnormalities able to be conceived by humans can be obtained.

The present disclosure has been devised in view of the foregoing circumstances and provides a technique for generating data used to construct a model for estimating an abnormal portion.

### Solution to Problem

According to an aspect of the present disclosure, a learning data generation apparatus generating learning data used to learn a model for estimating an abnormal portion of an ICT system includes: a learning unit configured to learn parameters of a generator and a discriminator forming a conditional hostile generative network by using observation data during abnormality of the ICT system; and a generation unit configured to generate the learning data using the generator in which the learned parameters are set.

### Advantageous Effects of Invention

A technique for generating data used to construct a model for estimating an abnormal portion is provided.

### BRIEF DESCRIPTION OF DRAWINGS

FIG. 1 is a diagram illustrating an example of CGAN.

FIG. 2 is a diagram illustrating an example of a hardware configuration of a learning data generation apparatus according to an embodiment.

FIG. 3 is a diagram illustrating an example of a functional configuration of the learning data generation apparatus according to the embodiment.

FIG. 4 is a flowchart illustrating an example a flow of processing performed by the learning data generation apparatus according to the embodiment.

### DESCRIPTION OF EMBODIMENTS

Hereinafter, an embodiment of the present invention will be described. Hereinafter, a learning data generation apparatus 10 for generating learning data used to construct a model for estimating an abnormal portion of the ICT system (for example, a causal model modeled by a Bayesian network or the like, a machine learning model such as a support-vector machine (SVM)) will be described.

### <Theoretical Configuration>

First, a theoretical configuration of a scheme in which the learning data generation apparatus 10 according to the embodiment generates learning data (hereinafter, also referred to as a proposal scheme) will be described.

In the present proposal scheme, learning data is generated using a conditional hostile generative network (CGAN: Reference Literature 1) generating abnormal data. Accordingly, abnormal data in an amount sufficient for learning a model for estimating an abnormal portion of the ICT system can be obtained as learning data. Since the CGAN generates abnormal data by inputting random data to a generator, various types of abnormal data can be generated. Therefore, for example, abnormal data which is difficult to obtain in chaos engineering can also be generated.

A case where the learning data is generated by the CGAN will be described below, but the present invention is not limited to the CGAN. Another model can be realized as long as the generation model is capable of designating at which position the abnormality occurs in abnormal data.

First, a data set in the past abnormality occurring in the ICT system is assumed to be X={x₁, . . . , x_{N}}. Here, xᵢ is a k-dimensional vector representing past abnormal data. k is the number of types of data, such as a traffic amount collected from the ICT system and a central processing unit (CPU) usage rate. That is, each xᵢ represents any of various states such as a traffic amount and a CPU usage rate when the ICT system is abnormal. N is the number of pieces of abnormal data. Each xᵢ may have a data value at a certain time as an element, or may have a statistical value such as an average of data values in a certain time duration as an element.

Data representing an abnormal portion when the abnormality occurs with regard to the abnormal data xᵢ is represented by y₁, and a data set formed by the abnormal portion data y₁ is represented by Y={y₁, . . . , y_{N}}. Here, y₁ is an l-dimensional (where, l is a lower case letter of L) vector. l denotes the number of apparatuses in the ICT system. It is assumed that each element of yᵢ corresponds to each apparatus in the ICT system. However, the present invention is not limited thereto. For example, each element of yᵢ corresponds to an I/F of an apparatus or a device built into the apparatus. When each element of yᵢ corresponds to an I/F of the apparatus, it is possible to estimate an abnormal portion in units of I/Fs. When each element corresponds to a device built into the apparatus, it is possible to estimate an abnormal portion in units of devices.

It is assumed that yᵢ is a one-hot vector in which only a j∈{1, . . . , j}-th element corresponding to the abnormal portion is 1, and the other elements are 0.

Hereinafter, it is assumed that the data sets X and Y are formed by data observed when abnormality occurs in an actual ICT system, but the present invention is not limited thereto. For example, the data sets X and Y may be formed by data generated by the chaos engineering, or data observed when abnormality occurs in an actual ICT system and data generated by the chaos engineering may be mixed.

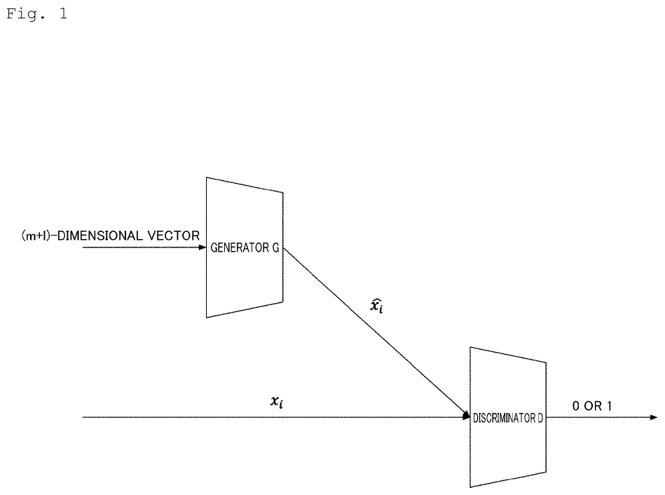

In this proposal scheme, the CGAN illustrated in FIG. 1 is learned using the data sets X and Y. As illustrated in FIG. 1, the CGAN includes a generator G (⋅; θ_{G}) and a discriminator D (⋅; θ_{D}) realized by a neural network. Here, θ_{D} and θ_{G} are parameters.

The generator G (⋅; θ_{G}) accepts an m+ l-dimensional vector in which an m-dimensional vector generated at random and an l-dimensional vector are combined as an input, and outputs a k-dimensional vector.

$$[ Math . 1 ]$$

$${\hat{x}}_{i}$$

Hereinafter, in text of the present specification, a character in which “\hat{ }” of xᵢ as an accent will be referred to as “\hat{ }xᵢ”.

Although there are various methods for generating random m-dimensional vectors, for example, a method of sampling values of elements from a normal distribution with an average of 0 and a variance of 1 can be exemplified. In the learning of the generator G (⋅; θ_{G}), the parameter θ_{G} is learned so that an m-dimensional vector \hat{ }xᵢ output when an (m+l)-dimensional vector obtained by combining the m-dimensional vector generated at random and the 1-dimensional vector yᵢ having only the j-th element of 1 is input is similar to xᵢ. That is, the generator G (⋅; θ_{G}) learns the parameter θ_{G} so that data similar to abnormal data actually collected by the ICT system can be generated. In other words, this means that the parameter θ_{G} is learned so that an erroneous determination is made in the determination of the discriminator D (⋅; θD) to be described below.

The discriminator D (⋅; θ_{D}) accepts the k-dimensional vector as an input and outputs a scalar value of 0 or 1. One of the abnormal data xᵢ actually collected from the ICT system or the data \hat{ }xᵢ generated by the generator G is input to the discriminator D (⋅; θ_{D}), and it is determined whether xᵢ or \hat{ }xᵢ is input. The discriminator D (⋅; θ_{D}) outputs 1 when it is determined that xᵢ is input, and outputs 1 when it is determined that \hat{ }xᵢ is input. In the learning of the discriminator D (⋅; θ_{D}), the parameter θ_{D} is learned so that discrimination performance is enhanced.

By learning the generator G (⋅; θ_{G}) and the discriminator D (⋅; θ_{D}) as described above, the generator G (⋅; θ_{G}) can generate data close to the abnormal data actually collected by the ICT system.

A loss function L of the CGAN including the generator G (⋅; θ_{G}) and the discriminator D (⋅; θ_{D}) is shown in the following Formula (1).

$$[ Math . 2 ]$$

$$L ( {θ}_{G} , {θ}_{D} ) = 𝔼 [ log ( D ( x ) ) ] + 𝔼 [ log ( 1 - D ( G ( cot ( z , y ) ) ) ) ] \qquad ( 1 )$$

Here, E(⋅) is an expected value and z is an m-dimensional vector generated at random. z is also called noise. x∈X and y∈Y are abnormal portion data when abnormality occurs with regard to the abnormal data x∈X. Further, cot (z, y) is an operation of combining z and y to generate an (m+l)-dimensional vector.

Then, the parameters θ_{G} and θ_{D} are learned so as to minimize the loss function shown in the above Formula (1).

Specifically, the parameters θ_{G}, and θ_{D}, are learned by the following Formula (2).

$$[ Math . 3 ]$$

$${min}_{{θ}_{G}} {max}_{{θ}_{D}} L ( {θ}_{G} , {θ}_{D} ) = {min}_{{θ}_{G}} {max}_{{θ}_{D}} 𝔼 [ log ( D ( x ) ) ] + 𝔼 [ log ( 1 - D ( G ( cot ( z , y ) ) ) ) ] \qquad ( 2 )$$

It is conceivable that schemes of updating various parameters, and an appropriate scheme may be used among known updating schemes.

After learning is performed by the above Formula (2), learning data is generated by the generator G (⋅; θ_{G}) having the learned parameter θ_{G}. Specifically, the (m+l)-dimensional vector obtained by combining an m-dimensional vector z generated at random and an 1-dimensional vector y generated at random is input to the learned generator G (⋅; θ_{G}), and the k-dimensional vector \hat{ }x is obtained as an output. Accordingly, learning data (\hat{ }x, y) for constructing a model for estimating an abnormal portion of the ICT system (for example, the causal model modeled by a Bayesian network or the like, a machine learning model such as SVM) can be obtained. The l-dimensional vector y is, for example, a one-hot vector in which only the j-th vector is set to 1 at random due to a uniform distribution or the like.

### <Hardware Configuration of Learning Data Generation Apparatus 10>

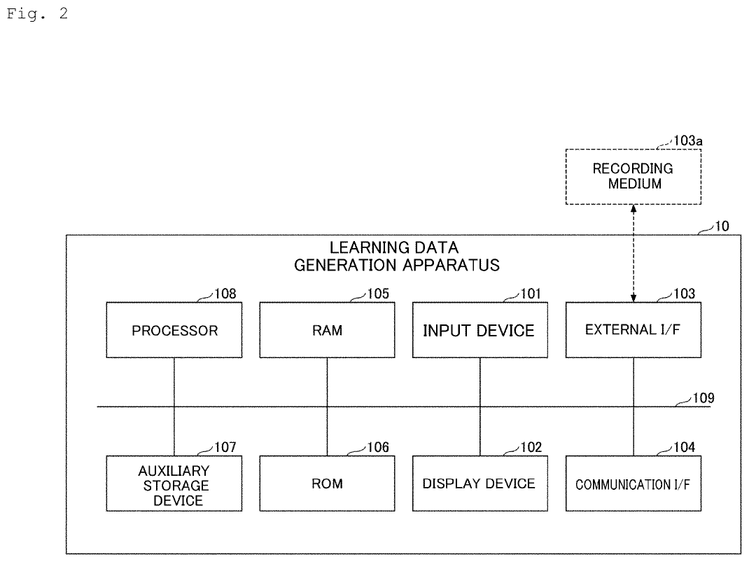

FIG. 2 illustrates a hardware configuration example of the learning data generation apparatus 10 according to the embodiment. As illustrated in FIG. 2, the learning data generation apparatus 10 according to the embodiment includes an input device 101, a display device 102, an external I/F 103, a communication I/F 104, a random access memory (RAM) 105, a read only memory (ROM) 106, an auxiliary storage device 107, and a processor 108. The hardware is communicatively connected via a bus 109.

The input device 101 is, for example, a keyboard, a mouse, a touch panel, various physical buttons, or the like. The display device 102 is, for example, a display or a display panel. The learning data generation apparatus 10 may not include at least one of the input device 101 and the display device 102.

The external I/F 103 is an interface with an external device such as a recording medium 103a. The learning data generation apparatus 10 can perform reading and writing from and on the recording medium 103a via the external I/F 103. Examples of the recording medium 103a include a flexible disk, a compact disc (CD), a digital versatile disk (DVD), a secure digital (SD) memory card, and a Universal Serial Bus (USB) memory card.

The communication I/F 104 is an interface for connecting the learning data generation apparatus 10 to a communication network. The RAM 105 is a volatile semiconductor memory (storage device) that temporarily stores programs and data. The ROM 106 is a nonvolatile semiconductor memory (storage device) that can hold programs and data even when a power source is turned off. The auxiliary storage device 107 is a storage device such as a hard disk drive (HDD) or a solid state drive (SSD). Examples of the processor 108 include various arithmetic devices such as a CPU and a graphics processing unit (GPU).

The learning data generation apparatus 10 according to the embodiment can implement various types of processing which will be described below with the hardware configuration illustrated in FIG. 2. The hardware configuration illustrated in FIG. 2 is merely exemplary, and the hardware configuration of the learning data generation apparatus 10 is not limited thereto. For example, the learning data generation apparatus 10 may include a plurality of auxiliary storage devices 107 and a plurality of processors 108, or may have various pieces of hardware other than the illustrated hardware.

### <Functional Configuration of Learning Data Generation Apparatus 10>

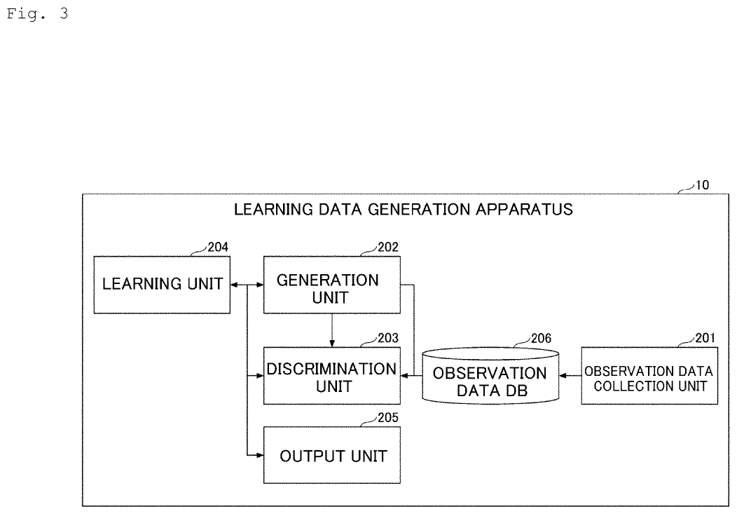

FIG. 3 illustrates a functional configuration example of the learning data generation apparatus 10 according to the embodiment. As illustrated in FIG. 3, the learning data generation apparatus 10 according to the embodiment includes an observation data collection unit 201, a generation unit 202, a discrimination unit 203, a learning unit 204, and an output unit 205. Each of these units is realized through, for example, processing executed by the processor 108 or the like according to one or more programs installed in the learning data generation apparatus 10. The learning data generation apparatus 10 according to the embodiment includes an observation data DB 206. The observation data DB 206 is realized by, for example, the auxiliary storage device 107. The observation data DB 206 may also be realized by, for example, a storage device connected to the learning data generation apparatus 10 via a communication network or the like.

The observation data collection unit 201 collects abnormal data x of the ICT system and abnormal portion data y when abnormality occurs. The abnormal data x and the abnormal portion data y are stored in the observation data DB 206. Accordingly, the data set X formed by the abnormal data x and the data set Y formed by the abnormal portion data y are stored in the observation data DB 206.

The generation unit 202 is realized by the generator G (⋅; θ_{G}), and accepts an (m+l)-dimensional vector as an input and outputs a k-dimensional vector.

The discrimination unit 203 is realized by the discriminator D (⋅; θ_{D}), and accepts the k-dimensional vector as an input and outputs a scalar value of 0 or 1.

The learning unit 204 learns the parameters θ_{G}, and θ_{D} by the above Formula (2).

The output unit 205 outputs various pieces of information to an output destination. For example, the output unit 205 outputs the k-dimensional vector output by the generation unit 202 and the scalar value output by the discrimination unit 203 to the display device 102 or the auxiliary storage device 107. For example, the output unit 205 outputs a set (\hat{ }x, y) of the k-dimensional vector \hat{ }x output by the generation unit 202 realized by the learned generator G (⋅; θ_{G}) and the l-dimensional vector y used at that time to the auxiliary storage device 107 or the like as learning data.

### <Flow of Processing Performed by Learning Data Generation Apparatus 10>

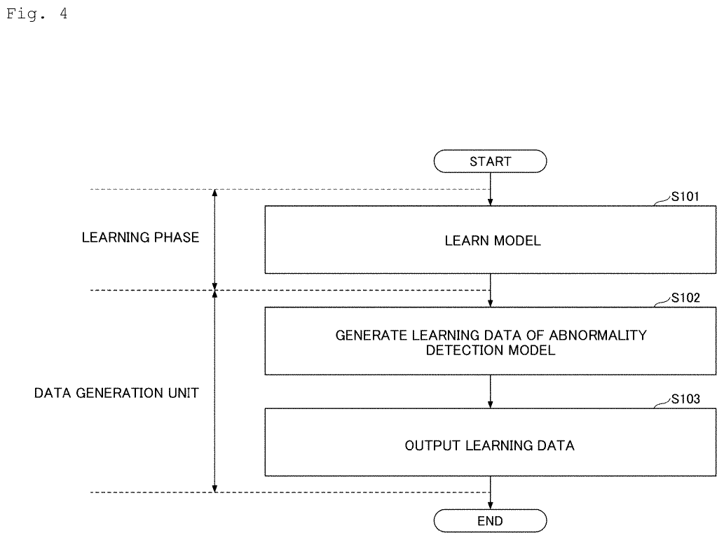

Hereinafter, a flow of processing performed by the learning data generation apparatus 10 will be described with reference to FIG. 4. Here, the learning data generation apparatus 10 includes a “learning phase” which is a phase for learning the parameters θ_{G} and θ_{D}, and a “data generation phase” which is a phase for generating learning data by the learned generator G (⋅; θ_{G}). The learning phase is performed earlier than the data generation phase. When a plurality of pieces of learning data are generated, steps S102 and S103 of the data generation phase may be repeatedly performed. Hereinafter, it is assumed that the data sets X and Y are stored in the observation data DB 206.

Step S101: the learning unit 204 learns the parameters θ_{G} and θ_{D} by the above Formula (2) using the data sets X and Y.

Step S102: the generation unit 202 generates an m-dimensional vector z at random and generates an 1-dimensional vector y (where y is a one-hot vector in which only a j-th element is 1) at random, inputs an (m+l)-dimensional vector obtained by combining z and y to the learned generator G (⋅; θ_{G}), and generates a k-dimensional vector \hat{ }x as an output. Accordingly, the learning data (\hat{ }x, y) is obtained.

Step S103: the output unit 205 outputs the learning data (\hat{ }x, y) obtained in the foregoing step S102 to a predetermined output destination (for example, the auxiliary storage device 107 or the like).

### <Conclusion>

As described above, the learning data generation apparatus 10 according to the embodiment can learn the CGAN using the observation data (x, y) during abnormality of the ICT system and can generate the learning data (\hat{ }x, y) for constructing a model for estimating an abnormal portion of the ICT system by the generator G included in the CGAN. Accordingly, a sufficient amount of learning data necessary to construct the model can be obtained.

Further, the generator G accepts a vector in which a vector z generated at random and a one-hot vector y generated at random are combined as an input, and generates abnormal data \hat{ }x. Therefore, for example, abnormal data which is difficult to obtain in the chaos engineering can also be generated. Accordingly, by using the learning data generated by the learning data generation apparatus 10 according to the embodiment, it is possible to construct a model capable of estimating an abnormal portion with high accuracy.

The present invention is not limited to the specifically disclosed embodiments, and various modifications, changes, combinations with known techniques, and the like can be made without departing from the scope of the claims.

### REFERENCE LITERATURE

Reference Document 1: Mehdi, O. Simon, “Conditional generative adversarial nets,” arXiv preprint arXiv:1411.1784, 2014.

### REFERENCE SIGNS LIST

10 Learning data generation apparatus
101 Input device
102 Display device
103 External I/F
103a Recording medium
104 Communication I/F
105 RAM
106 ROM
107 Auxiliary storage device
108 Processor
109 Bus
201 Observation data collection unit
202 Generation unit
203 Discrimination unit
204 Learning unit
205 Output unit
206 Observation data DB

1. A learning data generation apparatus generating learning data used to learn a model for estimating an abnormal portion of an ICT system, the learning data generation apparatus comprising:
a hardware processor configured to
learn parameters of a generator and a discriminator forming a conditional hostile generative network by using observation data during abnormality of the ICT system; and
generate the learning data using the generator in which the learned parameters are set.

2. The learning data generation apparatus according to claim 1,
wherein the observation data includes an abnormality vector representing a state of the ICT system at an abnormal time and an abnormal portion vector represented by one-hot vector in which only an element corresponding to the abnormal portion of the ICT system is 1, and
wherein the hardware processor is configured to
learn an output when a vector in which a noise vector representing noise generated at random and an abnormal portion vector are combined is input to the generator and a parameter of the generator so that data similar to the abnormality vector is obtained, and
learn a parameter of the discriminator so that discrimination performance is enhanced when one of an output of the generator and the abnormality vector is input to the discriminator.

3. The learning data generation apparatus according to claim 2, wherein at least some of a plurality of pieces of the observation data includes observation data observed when a fault is inserted into the ICT system by a chaos engineering scheme.

4. The learning data generation apparatus according to claim 1,
wherein the hardware processor is configured to
input a vector in which a noise vector representing noise generated at random and a one-hot vector generated at random are combined to the generator, and
generate a set of the vector output from the generator and the one-hot vector as the learning data.

5. A learning data generation method executed by a computer that generates learning data used to learn a model for estimating an abnormal portion of an ICT system, the learning data generation method comprising:
learning parameters of a generator and a discriminator forming a conditional hostile generative network by using observation data during abnormality of the ICT system; and
generating the learning data using the generator in which the learned parameters are set.

6. A non-transitory computer-readable recording medium storing a program for causing a computer that generates learning data used to learn a model for estimating an abnormal portion of an ICT system to execute a process, the process comprising:
learning parameters of a generator and a discriminator forming a conditional hostile generative network by using observation data during abnormality of the ICT system; and
generating the learning data using the generator in which the learned parameters are set.
